(19) United States
(12) Patent Application Publication
(10) Pub. No.: US 2022/0126892 A1
(43) Pub. Date: Apr. 28, 2022

(54) FLANGED BRAKE SHOE

(71) Applicant: RFPC HOLDING CORP., Wilmerding, PA (US)

(72) Inventor: A. Gary Bowden, Laurinburg, NC (US)

(21) Appl. No.: 17/427,783

(22) PCT Filed: Feb. 26, 2020
(86) PCT No.: PCT/US20/19937

§ 371 Date: Aug. 2, 2021

Related U.S. Application Data
(60) Provisional application No. 62/810,423, filed on Feb. 26, 2019.

(51) Int. Cl. B61H 1/00; B60B 17/00; B60B 21/08; F16D 49/00; F16D 65/00; F16D 65/06; F16D 69/04

(52) U.S. Cl. CPC B61H 1/003; B60B 17/0065; B60B 21/08; F16D 69/0416; F16D 65/0037; F16D 65/062; F16D 49/00

(57) ABSTRACT

A brake shoe includes a backing plate configured to interface with a brake head of a vehicle. The backing plate includes a main body and a flange attached to the main body and configured to align the brake shoe on a wheel of the vehicle. The brake shoe also includes a composition friction material disposed on the backing plate, which defines a brake surface for engaging the wheel. The brake shoe may have one or more dimensional characteristics for facilitating alignment of the brake shoe with the wheel, e.g., a ratio of a shortest horizontal distance to a shortest vertical distance of the brake shoe may be at least 1.07 and no more than 1.25, or a ratio of a length of the main body of the brake shoe to a length of the flange may be at least 1.3 and not more than 1.7.

### CROSS-REFERENCE TO RELATED APPLICATIONS

This application is the National Phase (35 U.S.C. § 371) of International Application PCT/US20/19937, filed 26 Feb. 2020, which claims priority to U.S. Provisional Application No. 62/810,423 filed 26 Feb. 2019, both of which are hereby incorporated by reference in their entirety.

### FIELD

Embodiments of the subject matter herein relate to brake systems for vehicles. Other embodiments relate to brake shoes for vehicles, for example rail vehicles.

### BACKGROUND

Vehicle friction brakes typically work through selective actuation of a component of a brake system to press against a rotating part of the vehicle that is associated with movement of the overall vehicle, e.g., an axle or wheel. Friction between the brake system component and the rotating part causes the rotating part, and thereby the vehicle, to decelerate. In certain rail vehicles, the brake system of the rail vehicle includes a brake shoe, which carries a brake block or brake pad. The brake system is configured so that actuation of the brake shoe causes the brake shoe (e.g., the brake block or brake pad attached to the brake shoe) to press against a wheel of the rail vehicle, to cause the wheel and vehicle to decelerate.

U.S. Pat. No. 6,241,058 is directed to a brake shoe with an insert bonded to a backing plate. The brake shoe includes a tread conditioning insert and a wheel conditioning surface, but the brake shoe may not properly align with a wheel flange on the wheel of a rail vehicle. Misalignment or improper alignment may adversely affect braking, and/or result in non-uniform wear of the braking surface of the brake shoe. Additionally, the working surface of a tread conditioning insert may not properly or effectively condition the surface of the wheel, resulting in a failure to remove defects in the wheel, or damage of the wheel. Misalignment of the brake shoe also may result in damage to the composition friction material of the brake shoe, reducing the effective life of the brake shoe, and raising costs due to premature degradation of the brake shoe and/or wheel.

Russian Patent Application No. RU 2017119239 is directed to a brake shoe having a tread conditioning insert, wheel conditioning surface, and flange. Disadvantageously, even though the flange is configured to align with the wheel flange of a rail vehicle, alignment with the wheel still may be improper. Such misalignment with the wheel of the rail vehicle may result in the same problems described above regarding the brake shoe in U.S. Pat. No. 6,241,058.

### BRIEF DESCRIPTION

In accordance with one embodiment, a brake shoe includes a backing plate configured to interface with a brake head of a vehicle. The backing plate includes a main body and a flange attached to the main body and configured to align the brake shoe on a wheel of the vehicle. The brake shoe also includes a composition friction material disposed on the backing plate. The composition friction material defines a brake surface for engaging the wheel of the vehicle.

In accordance with one embodiment, a brake shoe includes a backing plate configured to interface with a brake head on a vehicle and a composition friction material disposed onto the backing plate to form a brake surface of the brake shoe for engaging a wheel of the vehicle. The composition friction material includes two opposing ends and two opposing lateral sides. The brake shoe further includes at least one wear indicator formed in the backing plate and the composition friction material at an intersection of one of the opposing ends, one of the lateral sides, and the backing plate. The at least one wear indicator has a width of no less than 3 millimeters and no more than 7 millimeters, a length of no less than 15 millimeters and no more than 25 millimeters, and a depth of no less than 9 millimeters and no more than 11 millimeters.

### BRIEF DESCRIPTION OF THE DRAWINGS

FIG. 1 is a plan view of one embodiment of a brake shoe;

FIG. 2 is a cross-section view of the brake shoe in FIG. 1, taken along line 2-2;

FIG. 3 is a plan view of one embodiment of a brake shoe;

FIG. 4 is a plan view of one embodiment of a brake shoe;

FIG. 5 is a cross-section view of the brake shoe in FIG. 4, taken along line 5-5;

FIG. 6 is a side view of one embodiment of a brake shoe, where the hidden lines represent the insert 116; and

FIGS. 7-11 are views of one embodiment of a brake shoe, where FIG. 7 is an end view, FIG. 8 is a detail view of region A of FIG. 11, FIG. 9 is a plan view, FIG. 10 is a side view, and FIG. 11 is a perspective view.

### DETAILED DESCRIPTION

Embodiments of the present disclosure relate to composition brake shoes for use on vehicles (e.g., to brake shoes that use a composite/composition friction material, or some other friction material other than cast iron or another solid metal, to form the braking surface). Other embodiments relate to composition brake shoes for reconditioning a wheel tread surface during normal brake application on a vehicle.

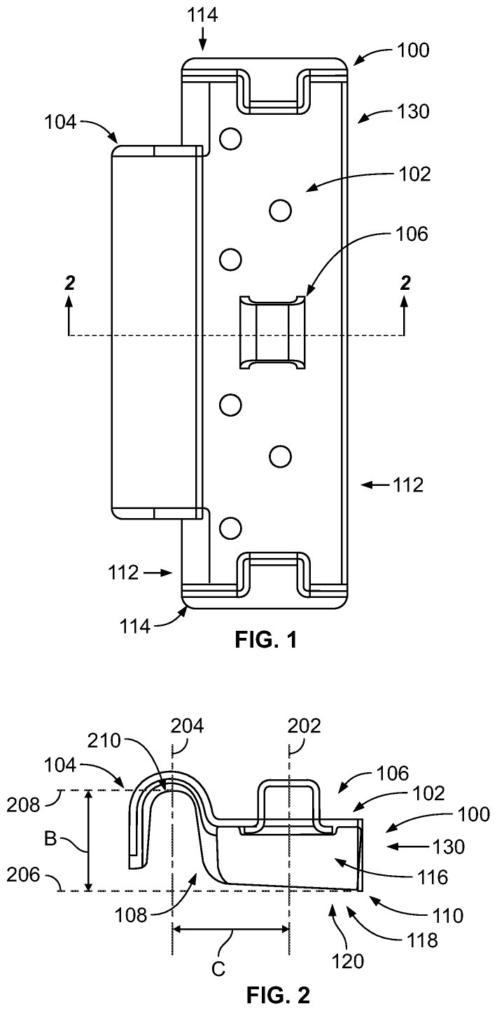

With reference to FIGS. 1-2, in one embodiment, a brake shoe 100 for use on a vehicle or other vehicle includes a backing plate 102 configured to interface with a brake head on the vehicle. The backing plate 102 includes a main body 130, and a flange 104 configured to align the brake shoe 100 on a wheel of the vehicle. Examples of the brake shoe 100 may include a keybridge 106 connected to the backing plate 102 and configured to secure the brake shoe 100 to the brake head of the vehicle. The brake shoe 100 includes a composition friction material 108 disposed onto the backing plate 102 to form a brake surface 110 of the brake shoe for engaging the wheel of the vehicle. An intermediate adhesion layer may be included to improve adhesion of the composition friction material 108 to the backing plate 102, with the intermediate adhesion layer being materially different than the composition friction material 108. One or more additional adhesive layers may be used to improve further adherence of the composition friction material 108 to the backing plate 102.

The composition friction material 108 disposed on the main body 130 includes two opposing lateral sides 112 and two opposing ends 114. The composition friction material may be disposed on the flange 104 as well. In any of the embodiments herein, the brake shoe 100 may also include at least one tread conditioning insert 116 disposed within the composition friction material 108, which includes a wheel conditioning surface 118 which forms a working surface 120 with the brake surface 110 of the brake shoe 100 that contacts the wheel during braking operations. The tread conditioning insert 116 may be formed of a hardened material, such as cast iron, but alternatively may be formed of any suitable material having abrasive properties. In examples, the tread conditioning insert 116 is disposed on or in the composition friction material 108 disposed on the main body 130.

In embodiments, a technical effect is to improve conditioning of a wheel of the vehicle, as well as the life of the brake shoe 100, by improving alignment of the brake shoe 100 with the wheel of a vehicle. Another aspect is to increase the working life of the brake shoe 100 by maintaining uniform wear of the brake surface 110 and working surface 120 of the brake shoe 100 by properly aligning the brake shoe 100 with a wheel of a vehicle.

In embodiments, in order to achieve this result, the brake shoe 100 may have a ratio of a dimension “C” to a dimension “B” of at least 1.07 and not more than 1.25, where dimension C is a shortest horizontal distance from a first vertical plane 202 bisecting the main body 130 lengthwise, to a second vertical plane 204 bisecting the flange 104 lengthwise. In examples, the first vertical plane 202 is parallel to the two opposing lateral sides 112 and bisects the keybridge 106, and the second vertical plane 204 is parallel to the first vertical plane 202 and bisects lengthwise a curved portion of the flange 104 of the backing plate 102. Dimension B is the shortest vertical distance from a first horizontal plane 206 to a second horizontal plane 208. The first horizontal plane 206 intersects a lowest vertical point of the working surface 120 disposed on the main body 130 at a point on a vertical plane (shown as line 2-2 in FIG. 1) bisecting the brake shoe 100 widthwise. The second horizontal plane 208 intersects a vertically highest point 210 of the brake surface 110 disposed on an inner portion of the flange 104.

For the purposes of the description herein, the terms “upper,” “lower,” “right,” “left,” “vertical,” “horizontal,” “parallel,” “perpendicular,” “top,” “bottom,” and derivatives and equivalents thereof shall relate to the brake shoe as it is oriented in the drawing figures. The term “length” and derivatives thereof refer to the longest dimension of the embodiment in question, as shown in the drawing figures. The term “height” and derivatives thereof refer to the vertical dimension of the embodiment in question, as shown in the drawing figures. The term “width” and derivatives thereof refer to the dimension that is perpendicular to both height and length. It is to be understood that the terms “vertical,” “horizontal,” “parallel,” “perpendicular,” and derivatives and equivalents thereof are approximate.

With the indicated ratio, the brake surface 110 and tread conditioning insert 116 are aligned with the flange 104 and surface of the wheel of a vehicle. This allows for improved contact between the flange 104 of the brake shoe 100 and the outside surface of the wheel flange, e.g., the length/dimensions of the flange provides for proper contact with the outside surface of the wheel flange. Ratios less than 1.07 or greater than 1.25 may result in a flange 104 that does not properly co-act with a wheel flange, or misalignment and misapplication of the brake surface 110 and/or wheel conditioning surface 118 of the tread conditioning insert 116.

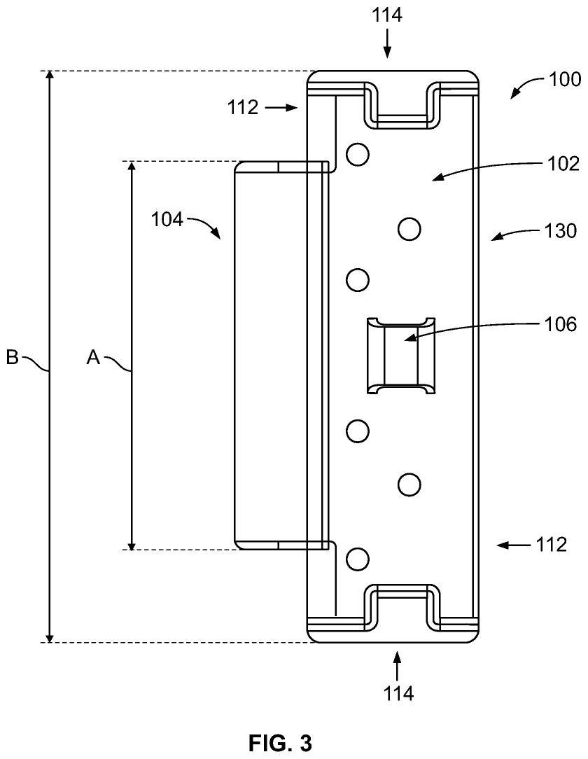

In one embodiment, with reference to FIG. 3, the brake shoe 100 may have a ratio of the length “B” of the brake shoe 100 between the two opposing ends 114 to the length “A” of the flange 104 of at least 1.3 and not more than 1.7. Thereby, conditioning of a wheel of the vehicle is improved, as well as the life of the brake shoe 100, since alignment of the brake shoe 100 with the wheel of a vehicle is improved. Further, binding forces that can occur between the brake shoe flange 104 and the wheel flange if the brake shoe flange 104 is too long are reduced. The indicated ratio allows the brake surface 110 to align with the tread surface of the wheel of a vehicle. The indicated ratio also may reduce binding forces between the brake shoe flange 104 and the wheel flange. Contrariwise, ratios of less than 1.3 may result in binding forces between the brake shoe flange and the wheel flange.

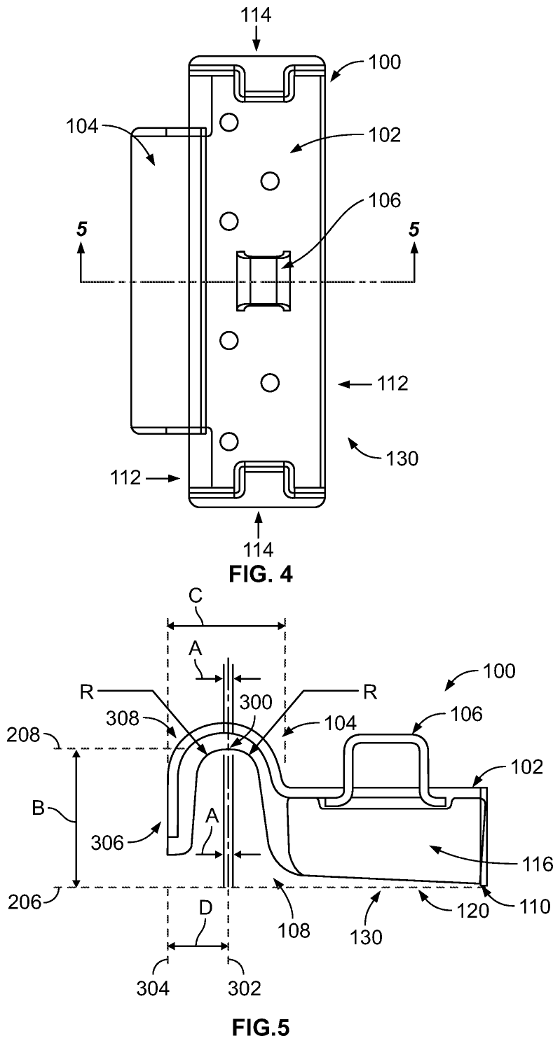

In one embodiment, with reference to FIGS. 4 and 5, the brake shoe 100 may have a ratio of dimension “B” to dimension “A” that is at least 12 and not more than 21. Dimension B is a shortest vertical distance from a first horizontal plane 206 to a second horizontal plane 208, wherein the first horizontal plane 206 intersects a lowest vertical point of the working surface 120 disposed on the main body 130 at a point on a vertical plane bisecting the brake shoe 100 widthwise. The second horizontal plane 208 intersects a vertically highest point of the brake surface 110 disposed on an inner portion of the flange 104. Dimension A is a width of a flat portion 300 of the brake surface 110 disposed on the inner portion of the flange 104 and intersecting the second horizontal plane 208. Such an embodiment may improve vehicle braking, as well as the life of the brake shoe 100, by improving alignment of the brake shoe 100 with the wheel of a vehicle. Also, in embodiments including one or more tread conditioning inserts, conditioning of the surface of the wheel may be improved. The indicated ratio results in improved alignment of the brake shoe flange 104 with a back side of the wheel flange, thus aiding the brake surface 110 to align with the wheel of a vehicle.

In one embodiment, with continued reference to FIGS. 4 and 5, the brake shoe 100 may have a ratio of a dimension “R” to the dimension A of at least 2 and not more than 6. Dimension R is a radius of curvature of the brake surface 110, disposed on at least one curved portion of the flange 104. Dimension A, as noted, is a width of a flat portion 300 of the brake surface 110 disposed at a vertically highest point of the inner portion of the flange 104. In examples, a flat portion 300 of the brake surface 110 inside the flange 104 may be provided to ensure that a sufficient amount of composition friction material 108 is disposed within the flange 104 of the brake shoe 100. Here, braking procedures applied to vehicles are improved, as well as the life of the brake shoe 100, by improving alignment of the brake shoe 100 with the wheel of a vehicle. Also, installation time may be reduced, and ease of installation of the brake shoe 100 may be improved. Another aspect, in embodiments including tread conditioning insert 116, is improved conditioning of the surface of the wheel. The indicated ratio allows for improved clearance between the top of the brake surface 110 inside the flange 104 of the brake shoe 100 and the top of the wheel flange. Similarly, this may improve ease of installation of the brake shoe 100.

In one embodiment, with continued reference to FIGS. 4 and 5, the brake shoe 100 may have a ratio of the dimension B to a dimension “C” that is at least 1.09 and not more than 1.23. As noted, dimension B is the shortest vertical distance from the first horizontal plane to the second horizontal plane, where the first horizontal plane intersects the lowest vertical point of the working surface disposed on the main body at the point on the vertical plane bisecting the brake shoe widthwise. The second horizontal plane intersects the vertically highest point of the brake surface disposed on the inner portion of the flange. Dimension C is an external horizontal width of the flange 104. This ratio may allow for improved alignment of the brake shoe flange 104 with a back side of the wheel flange, thus aiding the brake surface 110 to align with the wheel of a vehicle. Thereby, braking procedures applied to vehicles may be improved, as well as the life of the brake shoe 100, due to better alignment of the brake shoe 100 with the wheel of a vehicle. The indicated ration may also result in improved co-action of the flange 104 of the brake shoe 100 and the wheel flange without binding.

In one embodiment, with continued reference to FIGS. 4 and 5, the brake shoe 100 may have a ratio of a dimension “D” to the dimension R that is at least 2.0 and not more than 2.7. Dimension D is a shortest distance from a first vertical plane 302 to a second vertical plane 304 that is parallel to the first vertical plane 302. The first vertical plane 302 bisects a width of a flat portion 300 of the brake surface 110 disposed at a vertically highest point of the inner portion of the flange 104. The second vertical plane 304 bounds a vertically extending portion 306 of the flange 104. Dimension R, as noted, is a radius of curvature of the brake surface 110 disposed on at least one curved portion 308 of the flange 104. This ratio may result in improved alignment of the brake shoe flange 104 with the wheel flange, and improved clearance between the brake shoe flange 104 and the bottom of the wheel flange.

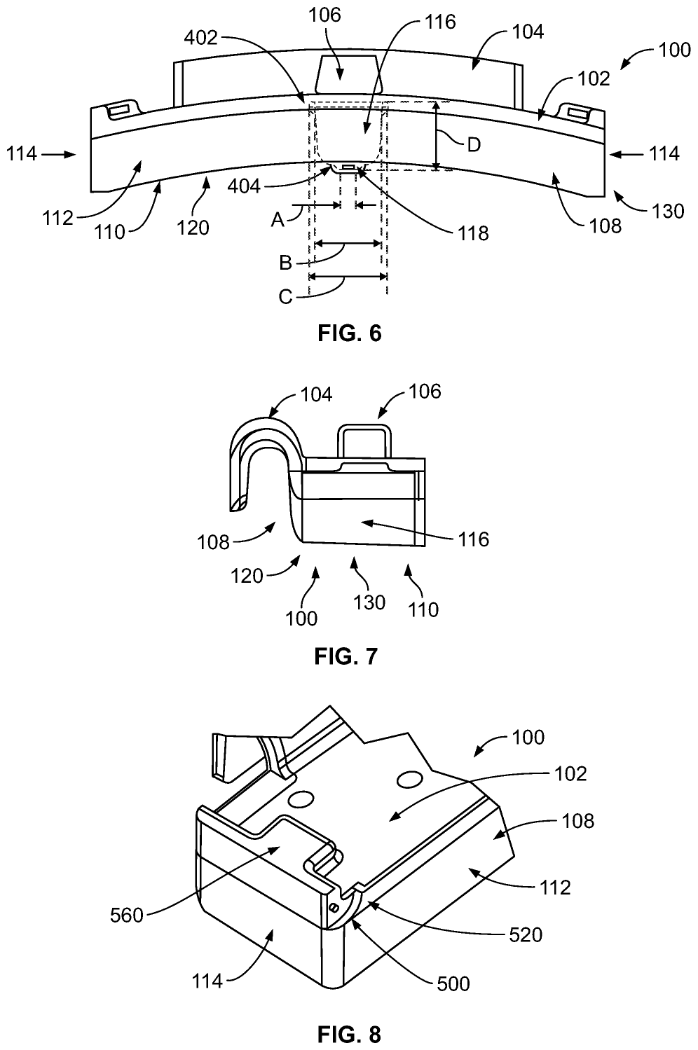

In one embodiment, with reference to FIG. 6, a brake shoe 100 for use on a vehicle includes a backing plate 102 configured to interface with a brake head on the vehicle. The backing plate 102 includes a main body 130. The backing plate 102 may include a flange 104 configured to align the brake shoe 100 on a wheel of the vehicle. Examples of the brake shoe 100 may include a keybridge 106 connected to the backing plate 102 and configured to secure the brake shoe 100 to the brake head of the vehicle. The brake shoe 100 includes a composition friction material 108 disposed onto the backing plate 102 to form a brake surface 110 of the brake shoe 100 for engaging the wheel of the vehicle. An intermediate adhesion layer may be included to improve adhesion of the composition friction material 108 to the backing plate 102, with the intermediate adhesion layer being materially different than the composition friction material 108. One or more additional adhesive layers may be used to improve further adherence of the composition friction material 108 to the backing plate 102.

The composition friction material 108 disposed on the main body 130 includes two opposing lateral sides 112 and two opposing ends 114. Composition friction material 108 may be disposed on the flange 104 as well. The brake shoe 100 includes at least one tread conditioning insert 116 disposed within the composition friction material 108. The tread conditioning insert 116 may be formed of a hardened material, such as cast iron, but may be formed of any suitable material having abrasive properties. In examples, the tread conditioning insert 116 is disposed on the composition friction material 108 disposed on the main body 130.

In operation, the wheel conditioning surface 118 of the tread conditioning insert 116 forms a working surface 120 with the brake surface 110 of the brake shoe 100 that contacts the wheel during braking operations. However, at the time of fabrication of the brake shoe 100, a portion 404 of the tread conditioning insert 116 may extend beyond the brake surface 110, creating a discontinuity in the working surface 120. This portion 404 additionally may be covered with composition friction material 108 during fabrication. The manufacturing process may include grinding or otherwise machining or otherwise removing away the portion 404 of the tread conditioning insert 116 extending beyond the brake surface 110, as well as any composition friction material 108 covering the same, prior to installation, in order to create a continuous working surface 120.

The brake shoe 100 may have a ratio of a dimension “D” to a dimension “A” of at least 3.3 and no greater than 4.7. Dimension D is a vertical height of the insert, and dimension A is a width of a portion 404 of the insert that is not covered by composition friction material 108 prior to grinding or other removal prior to initial use of the brake shoe. Providing a brake shoe with this ratio may reduce or eliminate the need to grind or otherwise machine or otherwise remove part of the tread conditioning insert 116 in order to result in a continuous working surface 120 of the brake shoe 100. It also ensures that a wheel conditioning surface 118 is exposed when the extended portion 404 is ground flush with the brake surface 110.

In one embodiment, still with reference to FIG. 6, the brake shoe 100 may alternatively or additionally have a ratio of the dimension D to a dimension “B” of at least 0.94 and no greater than 1.09. As noted, dimension D is the vertical height of the tread conditioning insert 116. Dimension B is a maximum width of the wheel conditioning surface 118. This ratio defines the working width of the wheel conditioning surface 118 of the tread conditioning insert 116 with respect to the thickness of the composition friction material 108 of the brake shoe 100. It is to be understood that the vertical height of the tread conditioning insert 116 depends on the thickness of the composition friction material 108 local to the position of the tread conditioning insert 116 in the brake shoe 100. With this ratio, the wheel conditioning surface 118 may be properly sized to provide proper conditioning to a wheel during braking procedures.

In one embodiment, still with reference to FIG. 6, the tread conditioning insert 116 of the brake shoe 100 may contact the backing plate 102 at a base 402. The base 402 may supply stability from torsional forces during braking procedures and may hold the tread conditioning insert 116 in place during manufacture. The brake shoe may alternatively or additionally have a ratio of the dimension D to a dimension “C” of at least 0.79 and no greater than 0.92. Dimension D, as noted, is a vertical height of the insert. Dimension C is a maximum width of the base 402 of the tread conditioning insert 116. With this ratio, the tread conditioning insert 116 includes a base 402 of sufficient size with respect to its height, i.e., a sufficient base 402 based on the height of the tread conditioning insert 116.

In one embodiment, still with reference to FIG. 6, alternatively or additionally, the brake shoe may have a ratio of dimension C to dimension A of at least 3.8 and no greater than 5.7. As noted, dimension C is a maximum width of the base of the insert, and dimension A is the width of the portion of the insert that is not covered by composition friction material prior to grinding or other removal (of said portion to form the working surface prior to initial use of the brake shoe). This ratio provides a sufficient base 402 based on the initial width of the tread conditioning insert 116, that is, the tread conditioning insert 116 includes a base 402 of sufficient size with respect to its initial width.

In one embodiment, still with reference to FIG. 6, alternatively or additionally, the brake shoe may have a ratio of dimension C to dimension B of at least 1.09 and no greater than 1.28. As noted, dimension C is a maximum width of the base 402 of the tread conditioning insert 116, and dimension B is a maximum width of the wheel conditioning surface 118. This ratio provides a sufficient base 402 based on the maximum width of the wheel conditioning surface 118 of the tread conditioning insert 116 to result in improved withstanding of torsional forces during braking procedures.

In one embodiment, a brake shoe for use on a vehicle includes a backing plate configured to interface with a brake head on the vehicle, and a composition friction material disposed onto the backing plate to form a brake surface of the brake shoe for engaging the wheel of the vehicle. The composition friction material includes two opposing ends and two opposing lateral sides. The brake shoe also includes at least one wear indicator formed in the backing plate and the composition friction material at an intersection of one of the opposing ends, one of the lateral sides, and the backing plate. The at least one wear indicator comprises a width of no less than 3 millimeters and no more than 7 millimeters. In one embodiment, the width is 5 millimeters. The at least one wear indicator may include a depth of no less than 9 millimeters, and no more than 11 millimeters. In one embodiment, the depth is 10 millimeters. The at least one wear indicator may include a length of no less than 15 millimeters, and no more than 25 millimeters. In one embodiment, the length is 20 millimeters. The at least one wear indicator may include a substantially curved portion having a radius of no less than 11 millimeters, and no more than 15 millimeters. In one embodiment, the radius is 13 millimeters. The at least one wear indicator may include one or more edges that meet at substantially right angles.

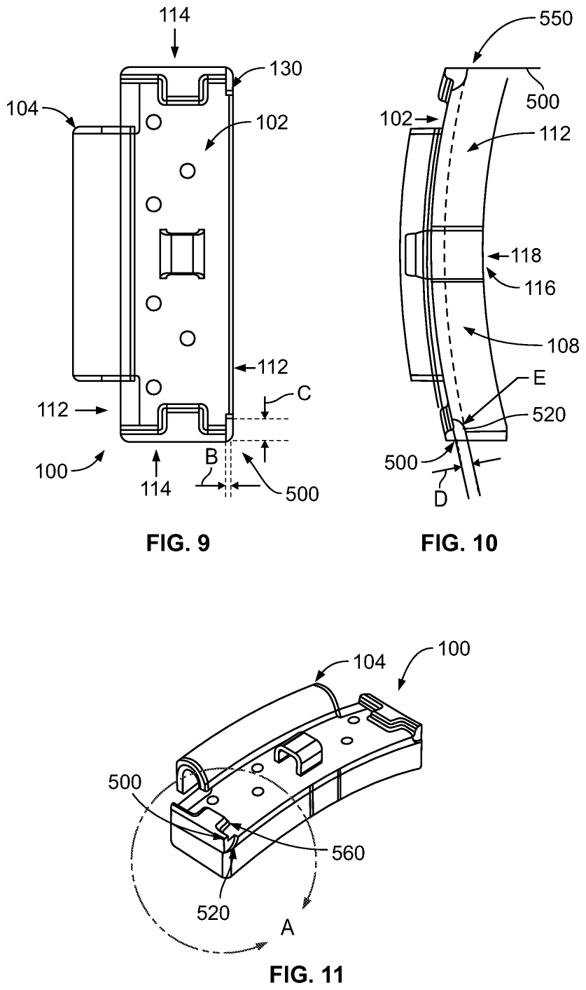

Turning now to FIGS. 7-11, a brake shoe 100 for use on a vehicle includes a backing plate 102 configured to interface with a brake head on the vehicle. The backing plate 102 includes a main body 130. Examples of the backing plate further may include a flange 104 configured to align the brake shoe 100 on a wheel of the vehicle. Examples of the brake shoe 100 may include a keybridge 106 connected to the backing plate 102 and configured to secure the brake shoe 100 to the brake head of the vehicle. The brake shoe 100 includes a composition friction material 108 disposed onto the backing plate 102 to form a brake surface 110 of the brake shoe for engaging the wheel of the vehicle. An intermediate adhesion layer may be included to improve adhesion of the composition friction material 108 to the backing plate 102, with the intermediate adhesion layer being materially different than the composition friction material 108. One or more additional adhesive layers may be used to improve further adherence of the composition friction material 108 to the backing plate 102.

The composition friction material 108 disposed on the main body 130 includes two opposing lateral sides 112 and two opposing ends 114. The composition friction material 108 may be disposed on a flange 104 as well. In embodiments, the brake shoe 100 may include at least one tread conditioning insert 116 disposed within the composition friction material 108, which includes a wheel conditioning surface 118 which forms a working surface 120 with the brake surface 110 of the brake shoe 100 that contacts the wheel during braking operations. The tread conditioning insert 116 may be formed of a hardened material, such as cast iron, but alternatively may be formed of any suitable material having abrasive properties. In examples, the tread conditioning insert 116 is disposed on the composition friction material 108 disposed on the main body 130. However, in embodiments, the brake shoe 100 may not include a tread conditioning insert 116. Other embodiments are applicable to brake shoes that do not include an insert 116, and/or a flange 104, as well.

To improve safety and efficiency by providing a means for a technician to easily determine whether a desired thickness of composition friction material 108 remains attached to the main body 130 of the backing plate 102 of the brake shoe 100, the brake shoe 100 includes at least one wear indicator 500 formed in the backing plate 102 and the composition friction material 108 at an intersection of an opposing end 114, and lateral side 112, and the backing plate 102. As shown, examples of the wear indicator 500 may include a substantially curved portion 520 with a radius. In other examples, the wear indicator 500 may include one or more edges that meet at substantially right angles. One or more wear indicators 500 may be formed on the brake shoe; however, in embodiments, at least one wear indicator 500 intersects a lateral side 112 of the brake shoe 100 in a position that is easily observable by a technician without removal of the brake shoe 100 while it is installed on the vehicle. In examples, this may be a lateral side 112 opposite to flange 104.

According to one aspect, formation of the wear indicator 500 into the backing plate 102 will not interfere with the use of a rejection lug 560. The at least one wear indicator may have a width B of no less than 3 millimeters and no more than 7 millimeters. The width B may be 5 millimeters. The depth D of the wear indicator 500 should be sufficient to allow a technician to observe, by comparison, whether a desired thickness of composition friction material 108 remains on the brake shoe 100. In examples, the depth D may encompass at least the condemnation limit 550 of composition friction material 108. Examples of the at least one wear indicator may include a depth D of no less than 9 millimeters, and no more than 11 millimeters, e.g., 10 millimeters. The at least one wear indicator 500 may include a length C of no less than 15 millimeters, and no more than 25 millimeters. The length C may be 20 millimeters. In examples, as shown in the figures, the at least one wear indicator 500 may include a substantially curved portion 520 having a radius E of no less than 11 millimeters, and no more than 15 millimeters. For example, the radius E may be 13 millimeters.

The wear indicator 500 allows a technician to easily determine whether a desired thickness of composition friction material 108 remains on the main body 130 of the brake shoe 100.

By providing a brake shoe with one or more of the dimensional characteristics described herein, e.g., one or more of the indicated dimensional ratios of various component parts of the brake shoe, shoe-wheel alignment may be improved (relative to brake shoes without such dimensional characteristics). Besides the other aspects described herein, it is contemplated that this may result in a 10-20% increased brake shoe life span, and a 15% or greater increase in wheel conditioning effectiveness, again, relative to brake shoes without such dimensional characteristics.

A brake shoe can include a backing plate configured to interface with a brake head of a vehicle. The backing plate ca include a main body and a flange attached to the main body and configured to align the brake shoe on a wheel of the vehicle. The brake shoe can also include a composition friction material disposed on the backing plate. The composition friction material may define a brake surface for engaging the wheel of the vehicle.

Optionally, the brake shoe also can include at least one tread conditioning insert disposed within the composition friction material. The insert can include a wheel conditioning surface, which forms a working surface in conjunction with the brake surface of the brake shoe that contacts the wheel during braking. That is, the wheel conditioning surface of the tread conditioning insert can be coextensive with the brake surface, with the two together acting as a working surface that contacts/engages the wheel during braking.

Optionally, a ratio of a shortest horizontal distance of the brake shoe to a shortest vertical distance of the brake shoe can be at least 1.07 and no more than 1.25. The shortest horizontal distance can be defined as extending from a first vertical plane bisecting the main body lengthwise to a second vertical plane bisecting the flange lengthwise. The shortest vertical distance can be defined as extending from a first horizontal plane to a second horizontal plane. The first horizontal plane intersects a lowest vertical point of the working surface disposed on the main body at a point on a vertical plane bisecting the brake shoe widthwise, and the second horizontal plane intersects a vertically highest point of the brake surface disposed on an inner portion of the flange.

Optionally, a ratio of a length of the main body of the brake shoe to a length of the flange can be at least 1.3 and not more than 1.7. Optionally, a ratio of a shortest vertical distance, from a first horizontal plane to a second horizontal plane, to a width of a flat portion of the brake surface disposed on the inner portion of the flange and intersecting the second horizontal plane, can be at least 12 and not more than 21. The first horizontal plane intersects a lowest vertical point of the working surface disposed on the main body at a point on a vertical plane bisecting the brake shoe widthwise. The second horizontal plane intersects a vertically highest point of the brake surface disposed on an inner portion of the flange.

Optionally, a ratio of a radius of curvature of the brake surface disposed on at least one curved portion of the flange to a width of a flat portion of the brake surface disposed at a vertically highest point of an inner portion of the flange can be at least 2 and not more than 6. Optionally, a ratio of a shortest vertical distance, from a first horizontal plane to a second horizontal plane, to an external horizontal width of the flange can be at least 1.09 and not more than 1.23. The first horizontal plane intersects a lowest vertical point of the working surface disposed on the main body at a point on a vertical plane bisecting the brake shoe widthwise. The second horizontal plane intersects a vertically highest point of the brake surface disposed on an inner portion of the flange.

Optionally, a ratio of a shortest distance, from a first vertical plane to a second vertical plane that is parallel to the first vertical plane, to a radius of curvature of the brake surface disposed on at least one curved portion of the flange can be at least 2.0 and not more than 2.7. The first vertical plane bisects a width of a flat portion of the brake surface disposed at a vertically highest point of an inner portion of the flange. The second vertical plane bounds a vertically extending portion of the flange.

Optionally, the brake shoe can include at least one tread conditioning insert disposed within the composition friction material. The brake shoe may have a ratio of a vertical height of the insert to a width of a portion of the insert that is not covered by the composition friction material prior to grinding (or other machining or other removal of that portion to form the working surface prior to initial use of the brake shoe) of at least 3.3 and no greater than 4.7.

Optionally, the brake shoe can include at least one tread conditioning insert disposed within the composition friction material. The brake shoe may have a ratio of a vertical height of the insert to a maximum width of the conditioning surface of at least 0.94 and no greater than 1.09. Optionally, the brake shoe can include at least one tread conditioning insert disposed within the composition friction material. The brake shoe may have a ratio of a vertical height of the insert to a maximum width of a base of the insert of at least 0.79 and no greater than 0.92.

Optionally, the brake shoe can include at least one tread conditioning insert disposed within the composition friction material. The brake shoe may have a ratio of a maximum width of a base of the insert to a width of a portion of the insert, which is not covered by the composition friction material prior to grinding or other removal of said portion to form the working surface prior to initial use of the brake shoe, of at least 3.8 and no greater than 5.7.

Optionally, brake shoe can include at least one tread conditioning insert disposed within the composition friction material. The brake shoe may have a ratio of a maximum width of a base of the insert to a maximum width of the conditioning surface of at least 1.09 and no greater than 1.28.

Optionally, where the brake shoe includes at least one tread conditioning insert disposed within the composition friction material and comprising a wheel conditioning surface which forms a working surface with the brake surface of the brake shoe that contacts the wheel during braking, the brake shoe may have plural of the characteristics described herein, e.g., it may have one or more of: a ratio of a maximum width of a base of the insert to a maximum width of the conditioning surface is at least 1.09 and no greater than 1.28; and/or a ratio of the maximum width of the base of the insert to a width of a portion of the insert that is not covered by the composition friction material prior to grinding or other removal of said portion to form the working surface prior to initial use of the brake shoe is at least 3.8 and no greater than 5.7; and/or a ratio of a vertical height of the insert to the maximum width of the base of the insert is at least 0.79 and no greater than 0.92; and/or a ratio of the vertical height of the insert to the maximum width of the conditioning surface is at least 0.94 and no greater than 1.09; and/or a ratio of the vertical height of the insert to the width of the portion of the insert that is not covered by the composition friction material prior to the grinding or other removal of said portion to form the working surface prior to initial use of the brake shoe is at least 3.3 and no greater than 4.7; and/or a ratio of a shortest vertical distance, from a first horizontal plane to a second horizontal plane, to an external horizontal width of the flange is at least 1.09 and not more than 1.23, wherein the first horizontal plane intersects a lowest vertical point of the working surface disposed on the main body at a point on a first vertical plane bisecting the brake shoe widthwise, and wherein the second horizontal plane intersects a vertically highest point of the brake surface disposed on an inner portion of the flange; and/or a ratio of the shortest vertical distance to a width of a flat portion of the brake surface disposed on the inner portion of the flange and intersecting the second horizontal plane, is at least 12 and not more than 21; and/or a ratio of a shortest horizontal distance to the shortest vertical distance is at least 1.07 and no more than 1.25, the shortest horizontal distance extending from a second vertical plane bisecting the main body lengthwise to a third vertical plane bisecting the flange lengthwise.

A brake shoe can include a backing plate configured to interface with a brake head on a vehicle and a composition friction material disposed onto the backing plate to form a brake surface of the brake shoe for engaging a wheel of the vehicle. The composition friction material can include two opposing ends and two opposing lateral sides. The brake shoe can further include at least one wear indicator formed in the backing plate and the composition friction material at an intersection of one of the opposing ends, one of the lateral sides, and the backing plate. The at least one wear indicator can have a width of no less than 3 millimeters and no more than 7 millimeters, a length of no less than 15 millimeters and no more than 25 millimeters, and a depth of no less than 9 millimeters and no more than 11 millimeters.

Optionally, the at least one wear indicator can include a substantially curved portion having a radius of no less than 11 millimeters and no more than 15 millimeters. Optionally, the radius of the substantially curved portion of the at least one wear indicator can be 13 millimeters. Optionally, the at least one wear indicator can further include one or more edges that meet at substantially right angles. Optionally, the width of the at least one wear indicator can be 5 millimeters, the depth of the at least one wear indicator can be 10 millimeters, and the length of the at least one wear indicator can be 20 millimeters.

Optionally, the brake shoe can include at least one tread conditioning insert disposed within the composition friction material and including a wheel conditioning surface which may form a working surface with the brake surface of the brake shoe that contacts the wheel during braking. Optionally a ratio of a maximum width of a base of the insert to a maximum width of the conditioning surface can be at least 1.09 and no greater than 1.28; and/or a ratio of the maximum width of the base of the insert to a width of a portion of the insert that is not covered by the composition friction material prior to grinding or other removal of said portion to form the working surface prior to initial use of the brake shoe can be at least 3.8 and no greater than 5.7; and/or a ratio of a vertical height of the insert to the maximum width of the base of the insert can be at least 0.79 and no greater than 0.92; and/or a ratio of the vertical height of the insert to the maximum width of the conditioning surface can be at least 0.94 and no greater than 1.09; and/or a ratio of the vertical height of the insert to the width of the portion of the insert that is not covered by the composition friction material prior to the grinding or other removal of said portion to form the working surface prior to initial use of the brake shoe can be at least 3.3 and no greater than 4.7; and/or a ratio of a shortest vertical distance, from a first horizontal plane to a second horizontal plane, to an external horizontal width of the flange can be at least 1.09 and not more than 1.23, and the first horizontal plane intersects a lowest vertical point of the working surface disposed on the main body at a point on a first vertical plane bisecting the brake shoe widthwise, and the second horizontal plane intersects a vertically highest point of the brake surface disposed on an inner portion of the flange; and/or a ratio of the shortest vertical distance to a width of a flat portion of the brake surface disposed on the inner portion of the flange and intersecting the second horizontal plane, can be at least 12 and not more than 21; and/or a ratio of a shortest horizontal distance to the shortest vertical distance can be at least 1.07 and no more than 1.25, the shortest horizontal distance extending from a second vertical plane bisecting the main body lengthwise to a third vertical plane bisecting the flange lengthwise. Optionally, a ratio of a length of the main body of the brake shoe to a length of the flange can be at least 1.3 and not more than 1.7, a ratio of a radius of curvature of the brake surface disposed on at least one curved portion of the flange to a width of a flat portion of the brake surface disposed at a vertically highest point of an inner portion of the flange can be at least 2 and not more than 6, and a ratio of a shortest distance, from a first vertical plane to a second vertical plane that is parallel to the first vertical plane, to a radius of curvature of the brake surface disposed on at least one curved portion of the flange can be at least 2.0 and not more than 2.7, and the first vertical plane bisects a width of a flat portion of the brake surface disposed at a vertically highest point of an inner portion of the flange, and the second vertical plane bounds a vertically extending portion of the flange

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, in the following claims, the phrases “at least A or B”, “A and/or B”, and “one or more of A or B” (where “A” and “B” represent claim elements), are used to encompass i) A, ii) B and/or iii) both A and B.

This written description uses examples to disclose the embodiments, including the best mode, and to enable those skilled in the art to practice the embodiments, including making and using any devices or systems and performing any incorporated methods. The claims define the patentable scope of the disclosure, and include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A brake shoe comprising:
a backing plate configured to interface with a brake head of a vehicle, the backing plate comprising a main body and a flange attached to the main body and configured to align the brake shoe on a wheel of the vehicle; and
a composition friction material disposed on the backing plate and defining a brake surface for engaging the wheel of the vehicle, wherein a ratio of a length of the main body of the brake shoe to a length of the flange is at least 1.3 and not more than 1.7.

2. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a shortest horizontal distance to a shortest vertical distance is at least 1.07 and no more than 1.25, the shortest horizontal distance extending from a first vertical plane bisecting the main body lengthwise to a second vertical plane bisecting the flange lengthwise, and the shortest vertical distance extending from a first horizontal plane to a second horizontal plane, wherein the first horizontal plane intersects a lowest vertical point of the working surface disposed on the main body at a point on a vertical plane bisecting the brake shoe widthwise, and wherein the second horizontal plane intersects a vertically highest point of the brake surface disposed on an inner portion of the flange.

3. (canceled)

4. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a shortest vertical distance, from a first horizontal plane to a second horizontal plane, to a width of a flat portion of the brake surface disposed on an inner portion of the flange and intersecting the second horizontal plane, is at least 12 and not more than 21, wherein the first horizontal plane intersects a lowest vertical point of the working surface disposed on the main body at a point on a vertical plane bisecting the brake shoe widthwise, and wherein the second horizontal plane intersects a vertically highest point of the brake surface disposed on an inner portion of the flange.

5. The brake shoe of claim 1, wherein a ratio of a radius of curvature of the brake surface disposed on at least one curved portion of the flange to a width of a flat portion of the brake surface disposed at a vertically highest point of an inner portion of the flange is at least 2 and not more than 6.

6. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a shortest vertical distance, from a first horizontal plane to a second horizontal plane, to an external horizontal width of the flange is at least 1.09 and not more than 1.23, wherein the first horizontal plane intersects a lowest vertical point of the working surface disposed on the main body at a point on a vertical plane bisecting the brake shoe widthwise, and wherein the second horizontal plane intersects a vertically highest point of the brake surface disposed on an inner portion of the flange.

7. The brake shoe of claim 1, wherein a ratio of a shortest distance, from a first vertical plane to a second vertical plane that is parallel to the first vertical plane, to a radius of curvature of the brake surface disposed on at least one curved portion of the flange is at least 2.0 and not more than 2.7, wherein the first vertical plane bisects a width of a flat portion of the brake surface disposed at a vertically highest point of an inner portion of the flange, and wherein the second vertical plane bounds a vertically extending portion of the flange.

8. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a vertical height of the insert to a width of a portion of the insert that is not covered by the composition friction material prior to grinding or other removal of said portion to form the working surface prior to initial use of the brake shoe is at least 3.3 and no greater than 4.7.

9. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a vertical height of the insert to a maximum width of the conditioning surface is at least 0.94 and no greater than 1.09.

10. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a vertical height of the insert to a maximum width of a base of the insert is at least 0.79 and no greater than 0.92.

11. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a maximum width of a base of the insert to a width of a portion of the insert that is not covered by the composition friction material prior to grinding or other removal of said portion to form the working surface prior to initial use of the brake shoe is at least 3.8 and no greater than 5.7.

12. The brake shoe of claim 1, further comprising at least one tread conditioning insert disposed within the composition friction material and comprising a wheel conditioning surface which forms a working surface with the brake surface of the brake shoe that contacts the wheel during braking, wherein a ratio of a maximum width of a base of the insert to a maximum width of the conditioning surface is at least 1.09 and no greater than 1.28.

13. (canceled)

14. A brake shoe comprising:
a backing plate configured to interface with a brake head on a vehicle;
a composition friction material disposed onto the backing plate to form a brake surface of the brake shoe for engaging a wheel of the vehicle, the composition friction material comprising two opposing ends and two opposing lateral sides; and
at least one wear indicator formed in the backing plate and the composition friction material at an intersection of one of the opposing ends, one of the lateral sides, and the backing plate,
wherein the at least one wear indicator comprises a width of no less than 3 millimeters and no more than 7 millimeters,
wherein the at least one wear indicator further comprises a length of no less than 15 millimeters and no more than 25 millimeters, and
wherein the at least one wear indicator further comprises a depth of no less than 9 millimeters and no more than 11 millimeters.

15. The brake shoe of claim 14, wherein the at least one wear indicator comprises a substantially curved portion having a radius of no less than 11 millimeters and no more than 15 millimeters.

16. (canceled)

17. The brake shoe of claim 14, wherein the at least one wear indicator further comprises one or more edges that meet at substantially right angles.

18. (canceled)

19. The brake shoe of claim 14, further comprising at least one tread conditioning insert disposed within the composition friction material and comprising a wheel conditioning surface which forms a working surface with the brake surface of the brake shoe that contacts the wheel during braking, wherein:
a ratio of a maximum width of a base of the insert to a maximum width of the conditioning surface is at least 1.09 and no greater than 1.28; and/or
a ratio of the maximum width of the base of the insert to a width of a portion of the insert that is not covered by the composition friction material prior to grinding or other removal of said portion to form the working surface prior to initial use of the brake shoe is at least 3.8 and no greater than 5.7; and/or
a ratio of a vertical height of the insert to the maximum width of the base of the insert is at least 0.79 and no greater than 0.92; and/or
a ratio of the vertical height of the insert to the maximum width of the conditioning surface is at least 0.94 and no greater than 1.09; and/or
a ratio of the vertical height of the insert to the width of the portion of the insert that is not covered by the composition friction material prior to the grinding or other removal of said portion to form the working surface prior to initial use of the brake shoe is at least 3.3 and no greater than 4.7; and/or
a ratio of a shortest vertical distance, from a first horizontal plane to a second horizontal plane, to an external horizontal width of a flange is at least 1.09 and not more than 1.23, wherein the first horizontal plane intersects a lowest vertical point of the working surface disposed on the main body at a point on a first vertical plane bisecting the brake shoe widthwise, and wherein the second horizontal plane intersects a vertically highest point of the brake surface disposed on an inner portion of the flange; and/or
a ratio of the shortest vertical distance to a width of a flat portion of the brake surface disposed on the inner portion of the flange and intersecting the second horizontal plane, is at least 12 and not more than 21; and/or
a ratio of a shortest horizontal distance to the shortest vertical distance is at least 1.07 and no more than 1.25, the shortest horizontal distance extending from a second vertical plane bisecting the main body lengthwise to a third vertical plane bisecting the flange lengthwise.

20. The brake shoe of claim 14, wherein a ratio of a length of the main body of the brake shoe to a length of the flange is at least 1.3 and not more than 1.7, a ratio of a radius of curvature of the brake surface disposed on at least one curved portion of the flange to a width of a flat portion of the brake surface disposed at a vertically highest point of an inner portion of the flange is at least 2 and not more than 6, and a ratio of a shortest distance, from a first vertical plane to a second vertical plane that is parallel to the first vertical plane, to a radius of curvature of the brake surface disposed on at least one curved portion of the flange is at least 2.0 and not more than 2.7, wherein the first vertical plane bisects a width of a flat portion of the brake surface disposed at a vertically highest point of an inner portion of the flange, and wherein the second vertical plane bounds a vertically extending portion of the flange.

21. A brake shoe comprising:
a backing plate configured to interface with a brake head of a vehicle, the backing plate comprising a main body and a flange attached to the main body and configured to align the brake shoe on a wheel of the vehicle;
a composition friction material disposed onto the backing plate to form a brake surface of the brake shoe for engaging a wheel of the vehicle, the composition friction material comprising two opposing ends and two opposing lateral sides;
at least one tread conditioning insert disposed within the composition friction material and comprising a wheel conditioning surface which forms a working surface with the brake surface of the brake shoe that contacts the wheel during braking; and
at least one wear indicator formed in the backing plate and the composition friction material at an intersection of one of the opposing ends, one of the lateral sides, and the backing plate.

22. The brake shoe of claim 21, wherein a ratio of a length of the main body of the brake shoe to a length of the flange is at least 1.3 and not more than 1.7, a ratio of a radius of curvature of the brake surface disposed on at least one curved portion of the flange to a width of a flat portion of the brake surface disposed at a vertically highest point of an inner portion of the flange is at least 2 and not more than 6, and a ratio of a shortest distance, from a first vertical plane to a second vertical plane that is parallel to the first vertical plane, to a radius of curvature of the brake surface disposed on at least one curved portion of the flange is at least 2.0 and not more than 2.7, wherein the first vertical plane bisects a width of a flat portion of the brake surface disposed at a vertically highest point of an inner portion of the flange, and wherein the second vertical plane bounds a vertically extending portion of the flange.

23. The brake shoe of claim 21, wherein:
a ratio of a maximum width of a base of the insert to a maximum width of the conditioning surface is at least 1.09 and no greater than 1.28; and/or
a ratio of the maximum width of the base of the insert to a width of a portion of the insert that is not covered by the composition friction material prior to grinding or other removal of said portion to form the working surface prior to initial use of the brake shoe is at least 3.8 and no greater than 5.7; and/or
a ratio of a vertical height of the insert to the maximum width of the base of the insert is at least 0.79 and no greater than 0.92; and/or
a ratio of the vertical height of the insert to the maximum width of the conditioning surface is at least 0.94 and no greater than 1.09; and/or
a ratio of the vertical height of the insert to the width of the portion of the insert that is not covered by the composition friction material prior to the grinding or other removal of said portion to form the working surface prior to initial use of the brake shoe is at least 3.3 and no greater than 4.7; and/or
a ratio of a shortest vertical distance, from a first horizontal plane to a second horizontal plane, to an external horizontal width of the flange is at least 1.09 and not more than 1.23, wherein the first horizontal plane intersects a lowest vertical point of the working surface disposed on the main body at a point on a first vertical plane bisecting the brake shoe widthwise, and wherein the second horizontal plane intersects a vertically highest point of the brake surface disposed on an inner portion of the flange; and/or
a ratio of the shortest vertical distance to a width of a flat portion of the brake surface disposed on the inner portion of the flange and intersecting the second horizontal plane, is at least 12 and not more than 21; and/or
a ratio of a shortest horizontal distance to the shortest vertical distance is at least 1.07 and no more than 1.25, the shortest horizontal distance extending from a second vertical plane bisecting the main body lengthwise to a third vertical plane bisecting the flange lengthwise.

24. The brake shoe of claim 21, wherein the at least one wear indicator comprises a width of no less than 3 millimeters and no more than 7 millimeters, a length of no less than 15 millimeters and no more than 25 millimeters, a depth of no less than 9 millimeters and no more than 11 millimeters, and a substantially curved portion having a radius of no less than 11 millimeters and no more than 15 millimeters.
